(19) United States
(12) Patent Application Publication
(10) Pub. No.: US 2004/0197218 A1
(43) Pub. Date: Oct. 7, 2004

(54) Cylinder structure for a pneumatic tool

(76) Inventors: Yu-Kun Wu, Tainan (TW); Yu-Lung Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/793,760

(22) Filed: Mar. 8, 2004

(30) Foreign Application Priority Data
Apr. 4, 2003 (TW) 092205553

(51) Int. Cl. F03C 2/00

(52) U.S. Cl. 418/270; 418/15

(57) ABSTRACT

A cylinder structure for a pneumatic tool includes a cylinder, a rotor, a front lid, and a rear lid. The cylinder has an eccentric chamber which has an inner wall in a series of different curvature sections connected to form an entire inner wall. The rotor is in touch by its outer edge against the inner wall of the chamber to form a contact surface in a zero distance, and a gap between the outer edge of the rotor and the inner wall of the chamber is gradually increasing towards both sides until an opposite side of the contacting surface.

### FIELD OF THE INVENTION

This invention relates to a cylinder structure for a pneumatic tool, and more particularly to a cylinder with an eccentric chamber that provides more torque of blades.

### BACKGROUND OF THE INVENTION

A conventional pneumatic tool uses an air compressor as the power source to drive a motor in the tool. A cylinder Al in the motor, as shown in FIG. 6, comprises an eccentric chamber A2. The inner wall of the chamber A2 is in a same curvature. The chamber A2 is provided with a rotator A3 therein. The outer edge of the rotor A3 is in touch with the inner wall of the chamber A2 in a zero distance, and the contact surface is defined as B. A gap between the outer edge of the rotor A3 and the inner wall of the chamber A2 is gradually increasing toward two sides until the opposite side of the contact surface B. The rotor A3 comprises a plurality of slots A4 around the outer edge of the rotor A3. Each slot A4 has a blade A5 therein. There are air inlets A6, back pressure air outlets A7 and an air outlet A8 on the side wall of the cylinder Al. When the rotor A3 spins counterclockwise, the air inlets A6 become back pressure air outlets whereas the original back pressure air outlets A7 become air inlets.

When operating the product, the pressured air sucked into the chamber A2 through the air inlets A6 pushes the blades A5 of the rotor A3 and the rotor A3 to spin. Upon the rotor A3 spins clockwise, the blades A5 are activated within the slots A4 to extend outwardly from the slots A4 along the rotor A3 and the inner wall of the chamber A2 and to partition the chamber A2 into several air chambers C. When the rotor A3 spins clockwise in a half circle, the air in each air chamber C is expelled through the air outlet A8. Upon the rotor A3 spins to a full cycle, the back pressure air in each air chamber C is expelled through the back pressure air outlets A7. (Should the rotor A3 spins counterclockwise, the pressured air is sucked in through the back pressure air outlets A7 and expelled through the air outlet A8 and the air inlets A6.) Each air chamber C has a different size depending upon the gap between the outer edge of the rotor A3 and the inner wall of the chamber A2. The opposite side of the contact surface B has the largest space. The larger the air chamber C, the faster the pushing force will be applied to the blade A5, and the more torque it will be. Therefore, in order to increase the torque, the larger the blade is required. This increases the cost and the weight of the cylinder.

### SUMMARY OF THE INVENTION

It is the primary object of the present invention to provide a cylinder structure for a pneumatic tool, which increases the capacity of a chamber to spin blades in a faster speed to produce a powerful torque.

It is another object of the present invention to provide a cylinder structure for a pneumatic tool, which does not change the size of the cylinder.

It is a further object of the present invention to provide a cylinder structure for a pneumatic tool, which is inexpensive in manufacture.

### BRIEF DESCRIPTION OF THE DRAWINGS

FIG. 1 is an exploded view of the present invention;

FIG. 2 is a top sectional view of the present invention;

FIG. 3 is a view similar to FIG. 2, with a rotor spinning in a clockwise direction;

FIG. 4 is a view similar to FIG. 2, with the rotor spinning in a counterclockwise direction;

FIG. 5 is a comparison of the chambers of the present invention and a conventional prior art, and

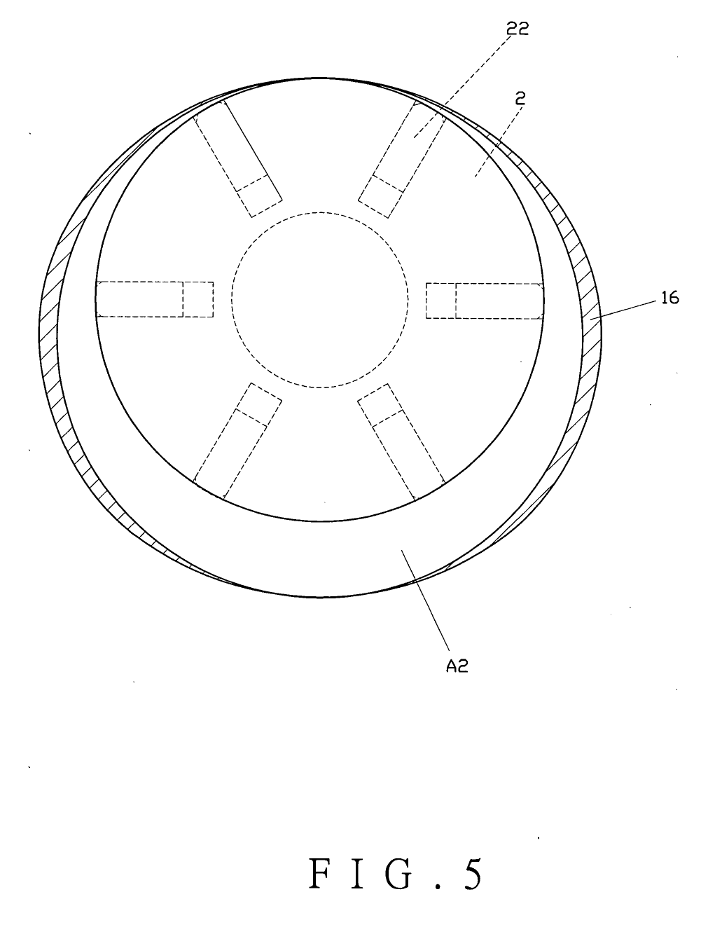

FIG. 6 is a top sectional view of a prior art.

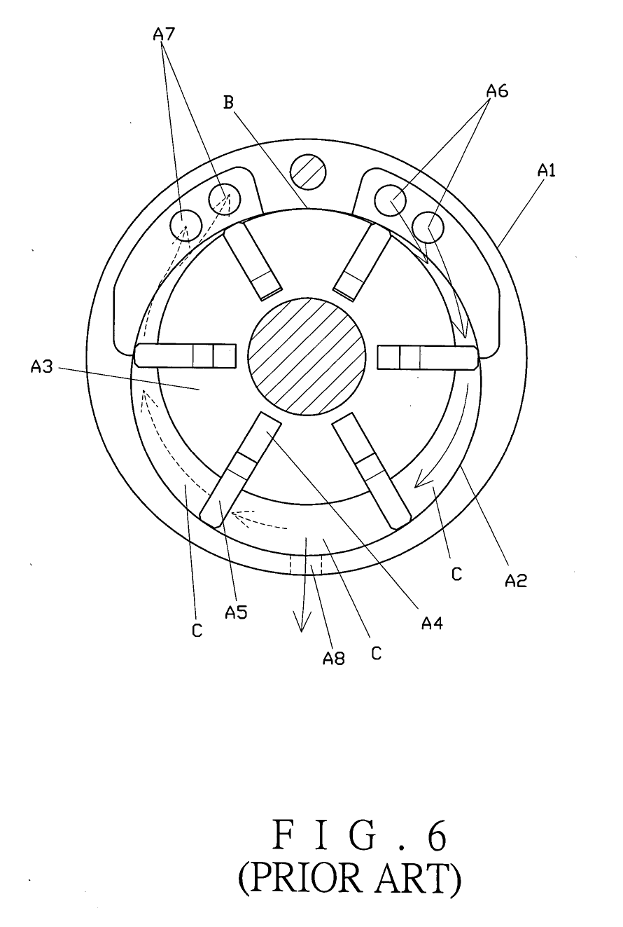

### DETAILED DESCRIPTION OF THE PREFERRED EMBODIMENT

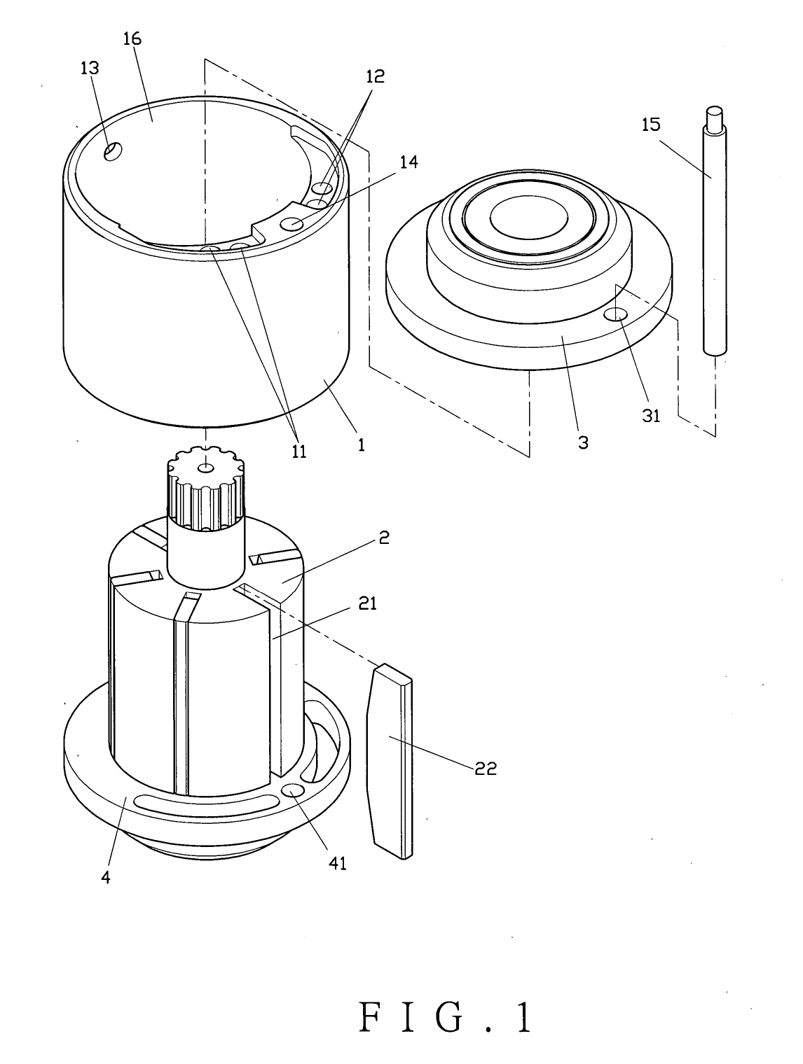

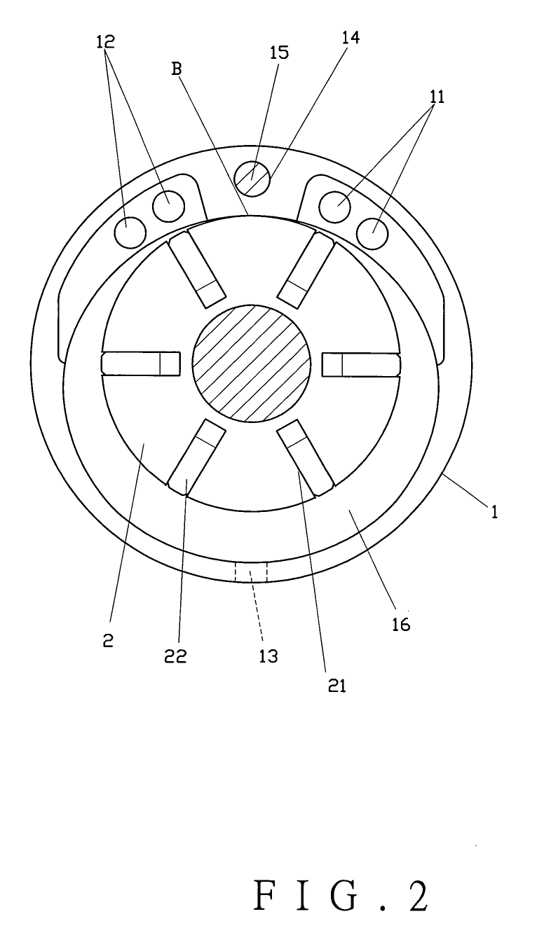

The present invention, as shown in FIGS. 1 and 2, comprises a cylinder 1, a rotor 2, a front lid 3, and a rear lid 4.

The cylinder 1 comprises a plurality of air inlets 11, back pressure air outlets 12 at a side wall. An air outlet 13 is formed on the opposite side of the air inlets 11 and the back pressure air outlets 12. A locating hole 14 is formed between the air inlets 11 and the back pressure air outlets 12. The locating hole 14 is adapted for a locating element 15 to insert therethrough. The cylinder 1 comprises an eccentric chamber 16 which has an inner wall in a series of different curvature sections connected to form an entire inner wall.

The rotor 2 is pivotally secured in the center position of the chamber 16 of the cylinder 1 and has a plurality of slots 21 around the outer edge of the rotor 2. Each slot 21 has a blade 22 therein.

The front lid 3 and the rear lid 4 are secured to the two ends of the cylinder 1. The front lid 3 has a locating hole 31. The rear lid 4 has a locating hole 41.

To assemble the present invention, as shown in FIG. 2, the rotor 2 is inserted into the chamber 16 of the cylinder 1, sealed with the front lid 3 and the rear lid 4, and secured by the locating element 15 through the locating holes 31 and 41 of the front lid 3 and the rear lid 4, and the locating hole 14 of the cylinder 1. The outer edge of the rotor 2 is in touch with the inner wall of the cylinder 1 to form a contact surface B in a zero distance. Due to the irregular round of the inner wall of the chamber 16, a gap between the outer edge of the rotor 2 and the inner wall of the chamber 16 is gradually increasing towards two sides till the air outlet 13 opposite the contact surface B.

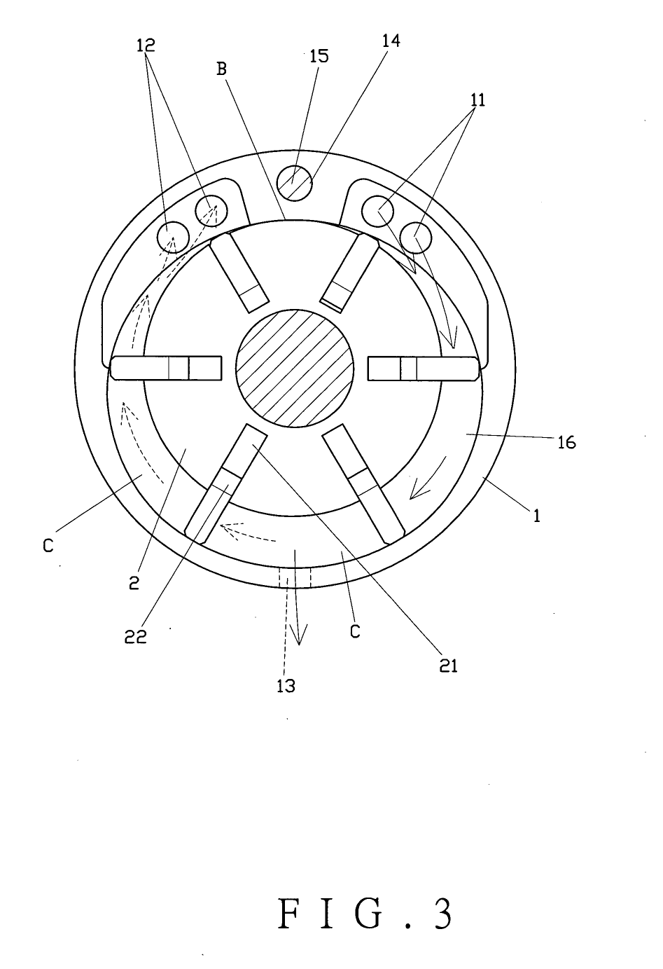

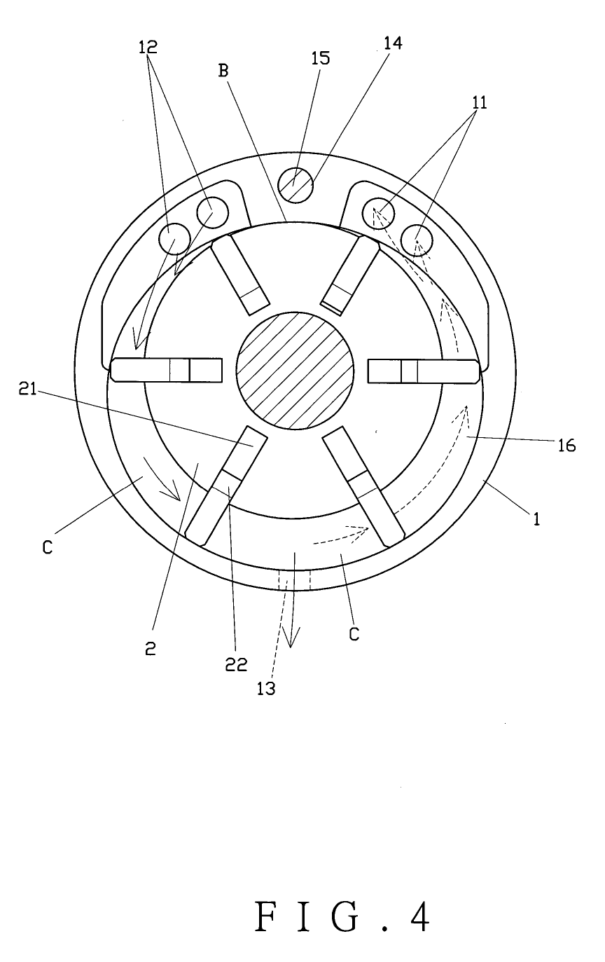

To operate the present invention, as shown in FIG. 3, the pressured air sucked into the chamber 16 through the air inlets 11 pushes the blades 22 of the rotor 2 and the rotor 2 to spin. The spinning produces a centrifugal force which extends the blades 22 outwardly from the slots 21. This extension of the blades 22 partitions the chamber 16 into several air rooms C. When the rotor 2 spins half cycle clockwise fill it reaches to the air outlet 13, the pressured air within each air room C expelled from the air outlet 13. When the rotor 2 spins to a full cycle, the back pressure air in each air room C expels from the back pressure air outlets 12. (When the rotor 2 spins counterclockwise, as shown in FIG. 4, the pressured air sucks from the back pressure air outlets 12 and expels from the air outlet 13 and the air inlets 11 subsequently. That is in an opposite way to the aforesaid.) Because the gap between the outer edge of the rotor 2 and the inner wall of the chamber 16 is gradually increasing, each air room C receives more pressured air and the blades 22 are moving faster, which increases the torque of the pneumatic tool incorporated this invention.

1. A cylinder structure for a pneumatic tool comprising:
a cylinder comprising air inlets and back pressure air outlets on a side wall, and an air outlet on an opposite side wall, said cylinder comprising an eccentric chamber;
a rotor pivotally secured in said chamber of said cylinder, said rotor being located in a center position of said chamber, said rotor comprising a plurality of slots around an outer edge of said rotor, each slot having a blade therein;
a front lid and a rear lid secured to two ends of said cylinder, and characterized in that:
said chamber comprising an inner wall with a series of different curvature wall connected to form an entire inner wall, said outer edge of said rotor being in touch with said inner wall of said chamber to form a contacting surface in a zero distance, a gap between said outer edge of said rotor and said inner wall of said chamber being gradually increasing towards two sides till an opposite side of said contacting surface.

2. The cylinder structure for a pneumatic tool, as recited in claim 1, wherein said cylinder, said front lid and said rear lid each comprises a locating hole for a locating element to insert therethrough to secure thereat.
